(19) United States
(12) Patent Application Publication
(10) Pub. No.: US 2023/0356569 A1
(43) Pub. Date: Nov. 9, 2023

(54) AIR DIFFUSER FOR A VEHICLE

(71) Applicant: GRAMMER AG, Jrsensollen (DE)

(72) Inventor: Alexander GRÜDL, Teuschnitz (DE)

(21) Appl. No.: 18/138,281

(22) Filed: Apr. 24, 2023

(30) Foreign Application Priority Data
Apr. 27, 2022 (DE) 10 2022 110 218.1

(51) Int. Cl. B60H 1/34

(52) U.S. Cl. CPC B60H 1/3414

(57) ABSTRACT

An air vent with a feed channel via which air can be fed, including a chamber to which the air can be supplied via the feed channel, and at least one air outlet via which the air can flow into the vehicle compartment. At least one movable partition is provided in the chamber, which partition can be moved into different positions by an adjustment device, in such a way that the airflow can be fed to at least one air outlet.

The invention relates to an air vent for a vehicle. Within the meaning of the invention, a vehicle is for example a land vehicle, aircraft or watercraft.

Air vents of this kind can be arranged in different regions of the vehicle passenger compartment, in order to guide an airflow in particular directions or to output said airflow only to the vehicle passenger compartment. For example, such air vents are generally located in the dashboard, the interior trim or in the center console, such that the air can be supplied to the upper front or rear region of the vehicle passenger compartment, the windows, or the foot well.

As public prior use, air vents are known which comprise, at the air outlet, a fin structure having a plurality of fins which can be adjusted in different directions and are movable into a closed position. The adjustment is generally performed manually by the seat occupant. The fins are visible from the outside. The air outlet had to be of a corresponding size in order that the fin structure could be integrated into the air outlet. The air outlet was for example optically adapted to the design of the vehicle passenger compartment, but impeded the free design of the vehicle passenger compartment.

An object of the invention was that of providing an air vent which can emit air in a directed manner from at least one air outlet. Furthermore, an object of the invention was that of designing the air vent in such a way that it impedes the design of the vehicle passenger compartment as little as possible.

The object is achieved by an air vent having the features of claim 1.

The air vent according to the invention comprises a feed channel via which air can be fed. The feed channel is formed for example by an attachment which can be connected to an air supply, e.g. a tube. Within the meaning of the invention, the feed channel can also form a simple opening of a chamber of the air vent.

An airflow can be supplied to the chamber via the feed channel. Furthermore, at least one airflow is guided out of the chamber. The chamber is provided for supplying the airflow to at least one air outlet, for splitting the airflow, and, if applicable, for blocking the airflow. At least the chamber is formed for example by a housing, for example a plastics housing. Even though the material of the chamber is not important, a desired shape of the chamber can always be easily achieved in the case of a plastics housing. The air vent comprises at least one air outlet, via which the air can flow out of the chamber and into the vehicle passenger compartment.

At least one movable partition is provided in the chamber, which partition can be arranged in different positions, by means of an adjustment device, in such a way that the airflow can be differently guided, split and blocked. For example, the air vent comprises just one air outlet. This can then be released by the partition, such that the airflow can flow out of the air outlet or can be blocked such that no airflow can pass through the outlet.

For example, the air vent comprises at least one first air outlet and one second air outlet. For example, the partition can be arranged such that the airflow can be fed to the first air outlet, while the second air outlet is blocked by the partition. According to a further arrangement of the partition, the airflow can be fed to the second air outlet for example, while the first air outlet is blocked by the partition. Another position of the partition provides, for example, for feeding the airflow to the first air outlet and the second air outlet.

An advantage of the air vent according to the invention is that a change of the outflow direction is achieved by the selection of the particular air outlet(s) through which the airflow emerges. In this way, the at least one air outlet does not change visually. The design of the vehicle passenger compartment is not impaired, visually, by the different positions of outlet fins. The air outlets can be designed for example as narrow slits, and in this way not be conspicuous to the vehicle occupant. It is possible for a plurality of such air vents to be integrated into the instrument panel or into a trim or into a console.

A center of rotation of the partition is guided for example on a circular path. Points spaced apart from the center of rotation, in particular end regions of the partition, move for example on a hypocycloid or an epicycloid. While the center of rotation of the partition, in particular the center point of the partition, moves on a circular path, the partition is rotated.

In this way, the different positions of the partition can advantageously be implemented, in a correspondingly designed chamber.

For example, the partition can, in addition to the positions already described above, be arranged such that the flow cross-section is closed. If the flow cross-section is substantially closed for example, no airflow or only a very small airflow can flow through the chamber. In this case, end regions of the partition are moved close to an inside wall defining the chamber, such that the entire flow cross-section is covered by the partition. For example, elastically deformable lips could be arranged at the end regions of the partition, which lips are movable into contact with the inside wall. The lips can come into contact with the inside wall of the chamber, and deform elastically. An even better sealing effect can be achieved thereby.

For example at least one faceplate is arranged between a first opening and a second opening of the chamber to the vehicle passenger compartment. The faceplate forms for example an air outlet region of the air outlet, at least in part. Each air outlet is for example assigned a defined outflow direction. The outflow direction can be defined for example by the shape of the reveal of the relevant air outlet. In this case, the reveal is for example formed by the faceplate, at least in part.

For example, functional elements, such as operating elements, lighting elements, displays, etc. are integrated into the faceplate. Use can thus be made of the space required by the faceplate.

The faceplate is designed for example as a decorative element. The faceplate can form the decorative element in its entirety, or can form a part of a decorative element.

The partition is shaped in a wing-like manner for example. In this way, it can be favorably subjected to an incident flow and a flow therearound. The wing-shaped partition has a low weight and can be moved easily. It occupies, itself, little space inside the chamber.

If the partition is shaped in a wing-like manner, but also in the case of other shapes, the faceplate can be formed for example as an extrusion part. This allows for cost-effective manufacture.

The reveal of at least one air outlet is formed for example by the faceplate and a wall defining the chamber. The shape of the reveal influences, for example, the outflow direction of the airflow. The wall of the chamber can for example be formed adjacently to the reveal, in such a way that the airflow is guided in the desired discharge direction. Alternatively, the air outlet can also be formed merely by one hosing wall of the air vent, or merely by the faceplate.

The reveal of the air outlet is shaped, for example, in such a way that the airflow is guided in a defined direction. The air discharge direction of the air outlet in question is constant. An overlap of the airflows of the respective air outlets can occur, however. Thus, for example the airflows of a first air outlet directed obliquely downwards, and of a second air outlet directed directly upwards, can overlap to form a horizontally oriented airflow.

In the case of intermediate positions of the partition, in which for example the partition is positioned in such a way that the partial flows of the airflow emerge from a first air outlet and from a second air outlet, the airflows may be different. For example, a larger airflow emerges from an air outlet which directs the airflow downwards, compared with an air outlet in the case of which the airflow is directed upwards. According to an alternative arrangement of the partition, a larger airflow emerges, for example, from the air outlet which directs the airflow upwards.

The adjustment device of the air vent comprises, for example, a drive. The drive serves for moving the partition. The drive is designed for example as an electric drive. Alternatively, however, the partition can also be manually movable. In the case of an electric drive, it is possible to set particular positions of the partition in a purposeful manner, or for example to regularly move the partition, for example in an oscillating manner.

The drive comprises, for example, a transmission. The transmission is a gear transmission for example. The movement of the drive can thereby be brought to a different rotational speed for example, and for example be provided with a specified movement characteristic. If a center of rotation of the partition moves on a circular path, the transmission can be formed by a ring gear transmission or by a transmission comprising a sun gear and planetary gears.

If, for example, the transmission is formed by a ring gear transmission, the partition can be moved into different positions within the chamber, wherein the partition is rotated and displaced in translation. In this way, different flow paths can be defined within the chamber, and the entire flow cross-section can, if necessary, be blocked.

By means of the partition, the chamber can be divided for example in such a way that at least one air outlet is blocked, while the airflow is supplied to at least one other air outlet. For example, the air vent comprises a first air outlet and a second air outlet. By means of the position it is possible, for example in a first position, for the entire airflow to flow through the first air outlet, while the second air outlet is blocked. In a second position of the partition, the entire airflow flows through the second air outlet, while the first air outlet is blocked.

In addition, the partition can be movable for example into a position in which the airflow is split, and a first partial flow of the airflow flows through the first air outlet, and a second partial flow flows through the second air outlet.

As already mentioned above, for example at least one air outlet is shaped in such a way that the airflow is guided in a specified direction upon emerging from the air vent. Within the meaning of the invention, an air outlet refers to a region of the air vent which forms an opening or via which the fed airflow or a part of said airflow can be emitted from the air vent to the vehicle passenger compartment. The air outlet comprises, for example, a region adjacent to the reveal of the opening, upstream of the reveal. Said region can already influence the outflow direction.

A first air outlet is for example shaped in such a way that the airflow is directed downwards. Air which flows out of the air outlet therefore essentially has a flow direction which is directed downwards. “Downwards” means, in this sense, that the outflow direction comprises at least one downward portion. For example, the air can flow obliquely downwards.

A second air outlet is for example shaped in such a way that the airflow is directed upwards. “Upwards” means, in this sense, that the outflow direction comprises at least one upward portion. For example, the air can flow obliquely upwards.

Two air outlets having different outflow directions are for example arranged and shaped in such a way that the emerging airflows overlap to form a third outflow direction. If, for example, the airflow is supplied to a first outlet having an obliquely upward outflow direction, and the second air outlet having an obliquely downward outflow direction, then the meeting airflows overlap one another to form an airflow which is directed forwards.

According to an embodiment, in addition to the partition at least one guide wall is conducted immovably or movably in the chamber. Said guide wall is for example arranged in such a way that at least a portion of the airflow is deflected laterally, relative to a main flow direction. The guide wall is for example fastened to the partition. For example, the guide wall forms an angle of 45° with the partition. A portion of the airflow can, in this way, also be laterally deflected and supplied to specific regions of the air outlet.

The partition is for example formed so as to be symmetrical with respect to each of two center point axes which are at right-angles to one another. The center point can for example be the center of gravity. The airflow can then flow uniformly around the partition on both sides. Said partition can have a convex shape, which tapers towards opposing end regions.

The partition can, however, alternatively also have other profiles, such as asymmetrical bearing surface profiles, linear, curved or biconcave profiles. The airflow emitted from the air vent can substantially also be influenced, by means of the profile of the partition, and thus for example a better deflection in a specific direction can be brought about.

According to a second aspect of the invention, the invention relates to a vehicle passenger compartment, wherein at least one region of the interior trim of the passenger compartment and/or of a console is provided with at least one air vent according to the first aspect of the invention. Within the meaning of the invention, trim is intended to mean, for example, the dashboard, the seat covers, covers at regions of a console, or at side regions of the passenger compartment.

With regard to the advantages of the invention, in order to avoid repetitions reference is made to the first aspect of the invention.

For example, at least two air vents are arranged in such a way that their air outlets are flush with one another. In this way, the air vent can be integrated in design lines of the vehicle in a visually unobtrusive manner. In this case, design lines which are arranged on a trim in the vehicle passenger compartment correspond for example to the design of the air outlet.

Embodiments of the invention are described by way of example in the following description of the figures, also with reference to the drawings. In this case, for the sake of clarity—also insofar as it is a question of different embodiments—identical or comparable parts or elements or regions are denoted by the same reference signs, sometime with addition of lower-case letters.

Within the context of the invention, features which are described only with reference to one embodiment can also be provided in any other embodiment of the invention. Such amended embodiments are also covered by the invention, even if they are not shown in the drawings.

All the features disclosed are essential to the invention in their own right. The content of the disclosure of the associated priority documents (copy of the prior application), and the cited documents and the described devices of the prior art are hereby also included, in their entirety, into the disclosure of the application, also for the purpose of incorporating one or more features of said documents into one or more claims of the present application.

In the schematic figures:

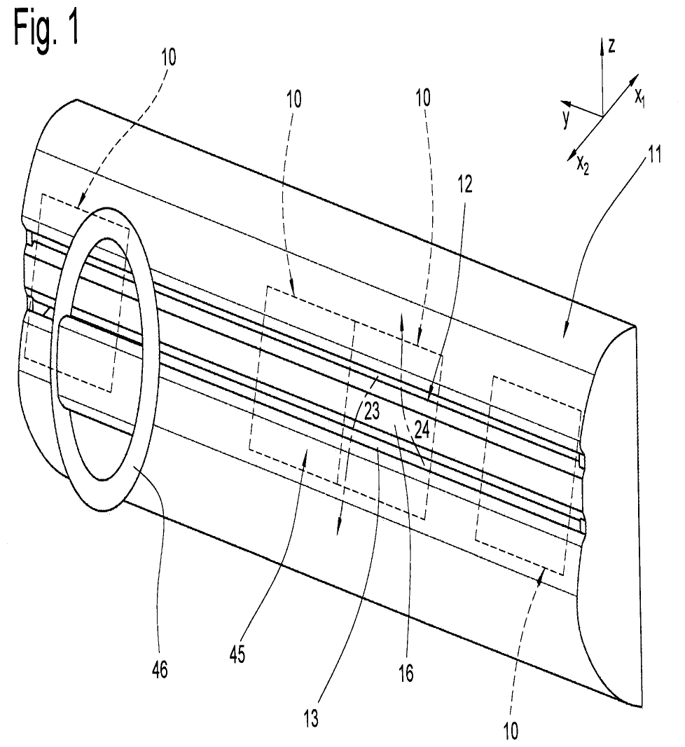

FIG. 1 is a perspective view of a dashboard in the front region of the passenger compartment,

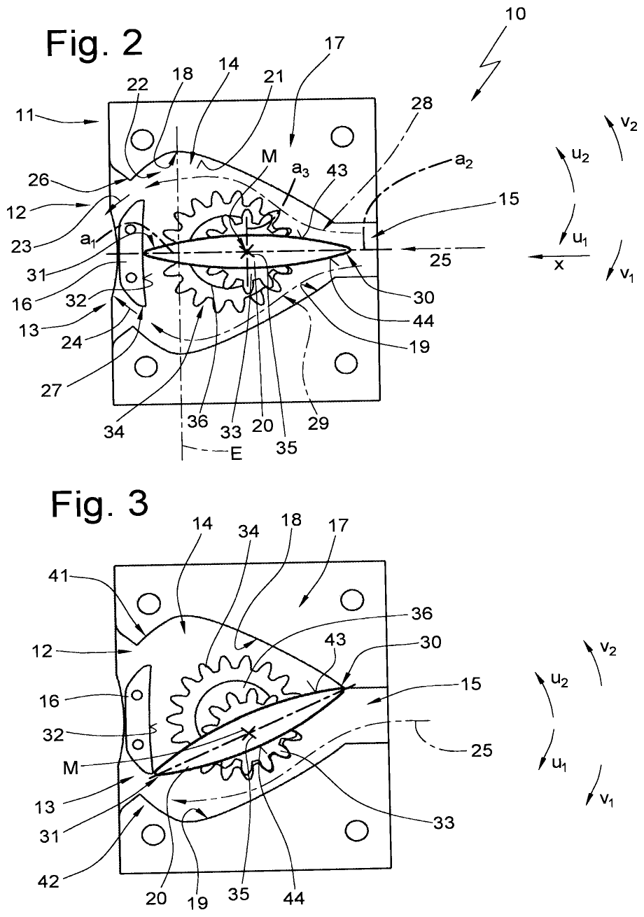

FIG. 2 is a sectional view of an air vent according to the invention, wherein the partition is arranged in a first position,

FIG. 3 is a sectional view of an air vent based on FIG. 2, wherein the partition is arranged in a second position,

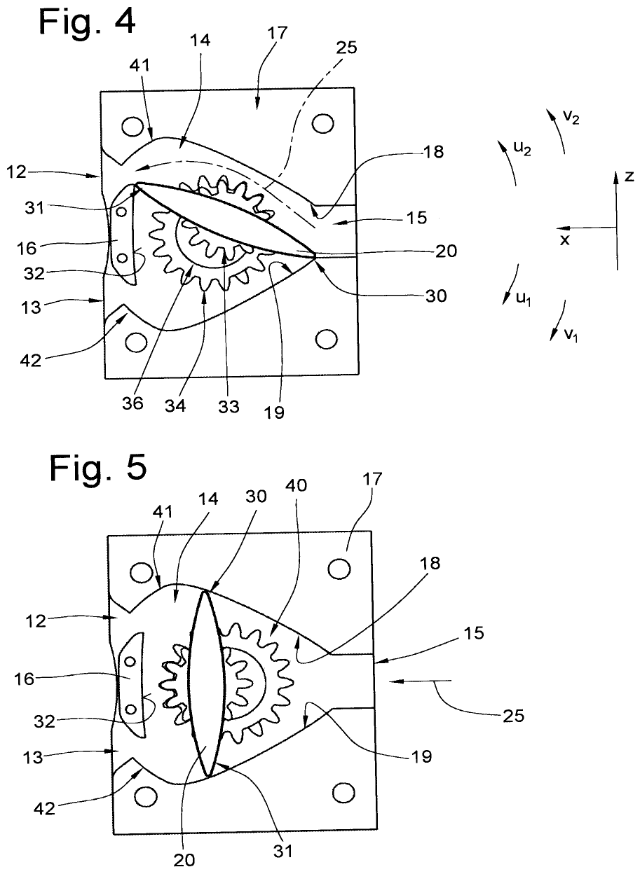

FIG. 4 shows the air vent based on FIG. 2, wherein the partition is arranged in a third position,

FIG. 5 shows the air vent based on FIG. 2, wherein the partition is arranged in a fourth position,

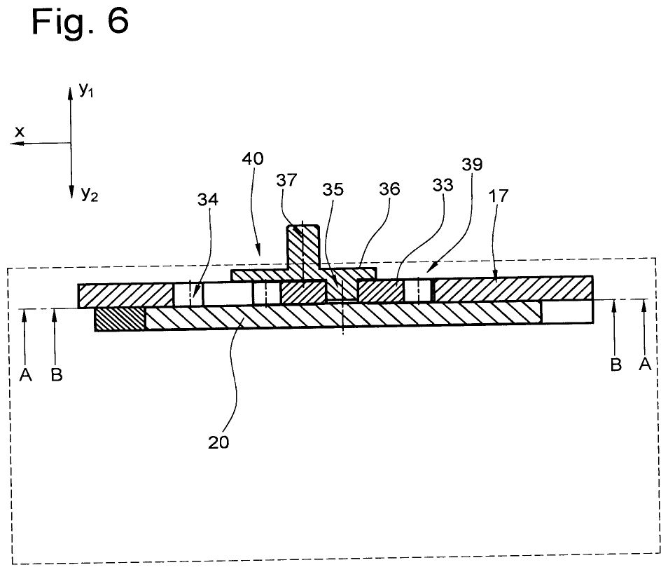

FIG. 6 is a plan view of the air vent,

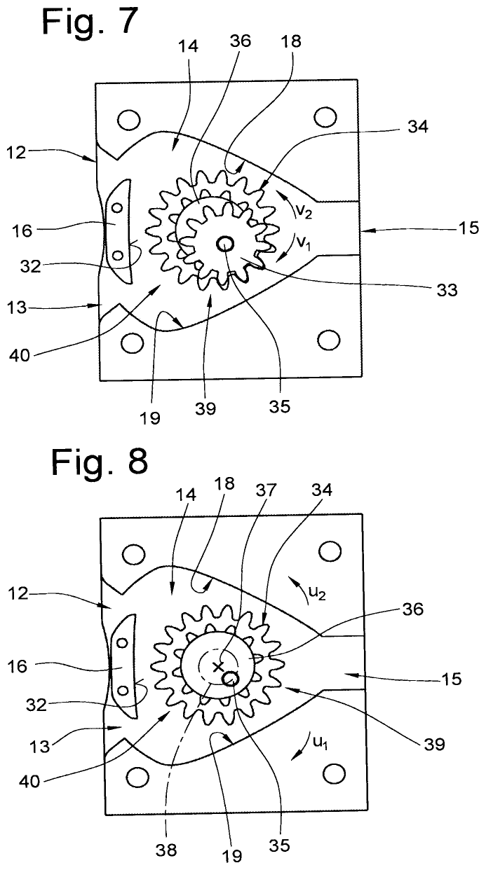

FIG. 7 is a sectional view according to sectional line A-A in FIG. 6,

FIG. 8 is a sectional view according to sectional line B-B in FIG. 6.

The air vent as a whole is denoted in the figures by the reference sign 10.

In FIG. 1, a dashboard 11 of a vehicle, comprising a steering wheel 46 (shown schematically) is visible, which dashboard is provided with a plurality of air vents 10 according to the invention. The arrangement of the air vents 10 is indicated in each case by a dashed line. All the air vents are of the same design. Therefore, just one air vent 10 is described in the following. Visually, a visible region 45 of the air vent 10 is adapted to the design of adjoining regions of the dashboard 1. In other word, the air vent does not stand out for the vehicle occupant, since it does not differ from the design of adjoining regions.

The air vent 10 comprises an upper slit-like air outlet 12 and a lower slit-like air outlet 13. The air outlets 12 and 13 extend in parallel, approximately horizontally. The air outlets 12 and 13 of the individual air vents 10 are flush with one another in each case.

The air outlets 12 and 13 are statically integrated into the dashboard 11. The upper air outlet 12 is for example designed in such a way that the air flows obliquely downwards (see outflow direction 23). The lower air outlet 13 is for example designed in such a way that the air flows out obliquely upwards (see outflow direction 24). The maximum flow direction of the respective air outlet 12 or 13 is predetermined on account of the shape of the air outlets and adjacent surface parts of the dashboard 11. However, it is possible to influence, for each air vent 10 separately or for example for a plurality of air vents 10 together, whether the airflow emerges from one of the air outlets 12 or 13, from both air outlets 12 and 13, or whether no airflow emerges from the air vent 10.

A longitudinal sectional view through the air vent 10 is shown in FIG. 2. Said air vent comprises a housing 17, in which a chamber 14 is formed. The airflow 25 flows in the direction x through an air inlet 15 into the chamber 14. The chamber 14 is delimited by an upper region 18, a lower region 19, and side regions 22 of an inside wall 21, wherein only one of the side regions 22 is visible in the figure.

The chamber 14 is of a bulbous shape. From the air inlet 15, the chamber 14 widens with an increasing x-direction with respect to the z-direction, as far as a plane E, and then tapers again. Thus, a particular flow direction is induced in the airflow 25.

The airflow 25 flows through the chamber 14 and is conducted to one of the air outlets 12 or 13. The airflow 25 can also be split in the chamber 14, such that a first partial flow 28 of the airflow 25 flows out via the air outlet 12, and a second partial flow 29 of the airflow 25 flows out via the air outlet 13.

An upper end region of a faceplate 16, together with the housing 17, forms a reveal 26 of the air outlet 12, and a lower end region of the faceplate 16, together with the housing 17, forms a reveal 27 of the air outlet 13.

A partition 20 comprising a first side surface 43 and a second side surface 44 is movably mounted in the chamber 14. The partition 20 has a streamlined, wing-shaped convex form having end regions 30 and 31. The partition 20 is symmetrical to an axis a1 and to an axis a3 which is perpendicular on the axis a1. The axes a1 and a3 extend through a center point M.

In FIG. 2 the partition 20 is arranged in such a way that the airflow 25 emerging from the air inlet 15 is split by the partition 20 and, downstream, forms two partial flows 28 and 29. For example, an end region 30 of the partition 20 is positioned on the air inlet 15, on a longitudinal central axis a2 of the air vent 10. A second end region 31 of the partition 20 approximately closes the faceplate 16 by means of an inside wall surface 32. In this case, the first partial flow 28 extends between the upper region 18 of the inside wall 12 and the side surface 43 of the partition 20, to the air outlet 12, and a second partial flow 29 extends between the lower region 19 and the side surface 44 of the partition 20, to the air outlet 13. In other words, the partial flows 28 and 29 emerge from the two air outlets 12 and 13.

According to FIG. 3, the partition 20 is arranged such that the air outlet 12 is closed. The end region 30 of the partition 20 is approximately flush with the upper region 18 of the inside wall 21 of the housing 17. The end region 31 is flush with a lower end region of the inside wall 32 of the faceplate 16. The airflow 25 can therefore flow only through the air outlet 13.

The position of the partition 20 according to FIG. 4 is such that the air outlet 13 is closed. The entire airflow 25 flows through the air outlet 12. The end region 30 of the partition 20 rests flush on a lower region 19 of the inside wall 21, while the end region 31 closes the inside wall 32 of the faceplate 16, by means of an upper end region.

According to FIG. 5, the end region 30 closes the inside wall 21, by means of the upper region 18, and the end region 31 closes the inside wall 21, by means of the lower region 19. In this case, an airflow does not emerge from either of the air outlets 12 and 13. The flow cross-section is blocked and the airflow 25 cannot pass through the chamber 14.

A portion 41 of the upper region 18 of the chamber 14 is of a shape which, together with the shape of the upper region of the faceplate 16, brings about a flow direction that is obliquely downwards in the direction 23. A portion 42 of the lower region 19 is shaped in such a way that, together with the shape of a lower region of the faceplate 16, it induces a flow direction that is obliquely upwards in the direction 24. The airflow of the air outlet 12 is therefore always in direction 23, i.e. directed obliquely downwards, and the airflow of the air outlet 13 is always in direction 24, i.e. directed obliquely upwards. In the case of partial flows 28 and 29, these overlap one another to form an airflow in direction x.

The air vent 10 comprises an adjustment device 40 for the partition 20, having a transmission 39 (see FIGS. 6 to 8, wherein the partition 20 is not shown in FIGS. 7 and 8). The transmission 39 comprises a carrier wheel 33 having an external toothing which is in engagement with an internal toothing of a ring gear 34. The carrier wheel 33 is rigidly connected to the partition 20 and is immovable relative to the partition 20. During the movement of the carrier wheel 33 in the ring gear 34, an eccentric shaft 35 moves on a circular path 38 (see FIG. 8). The carrier wheel 33 is rotatably mounted on the eccentric shaft 35. Said carrier wheel is driven by a drive wheel, on which the eccentric shaft 35 is arranged eccentrically with respect to a center point axis 37 of the drive wheel 36. The eccentric shaft 35 forms the center point M of the partition 20. The driving of the drive wheel 36 is not shown in greater detail here.

From the position according to FIG. 2, the drive wheel 36 (the drive wheel is shown without teeth in FIG. 2) rotates for example in direction u1, wherein, due to the rotational movement of the eccentric shaft 35 on the circular path 38, the partition 33 rolls on the toothing of the ring gear 34 and rotates in direction v2 about the eccentric shaft 25, until the position according to FIG. 3 is reached. Proceeding from the position according to FIG. 2, the position according to FIG. 4 can be reached in that the drive wheel 36 rotates for example in direction u2, wherein the carrier wheel 33 moves in direction v1. The position of the partition 20 according to FIG. 5 can be set, in that, proceeding from the position according to FIG. 3, the drive wheel 36 is moved further in direction u1 or, proceeding from the position according to FIG. 4, the drive wheel 36 is oved in direction u2.

The drive wheel 36 is driven for example by a motor (not shown), which can be actuated by means of a controller, so as to be movable in both rotation directions. Alternatively, for example a manual movement of the drive wheel 36 using a suitable actuation means, for example by means of an operating wheel that is freely rotatable, manually, about 360°, is also possible in order to set the different positions of the partition 20, and thus the type of air supply.

According to an alternative embodiment which is not shown, the partition 20 additionally comprises guide walls for laterally deflection of the airflow in the directions y1 and y2.

1-18. (canceled)

19. An air vent, comprising: at least one feed channel through which air is feedable; a chamber to which the air is fed via the feed channel; at least one air outlet via which the air flows into the vehicle compartment; at least one movable partition provided in the chamber; and, an adjustment device that moves the partition into different positions so that the airflow is fed to the at least one air outlet.

20. The air vent according to claim 19, wherein the partition has an axis of rotation of the partition that moves on a circular path.

21. The air vent according to claim 19, wherein a cross-section of the airflow is closable by the partition.

22. The air vent according to claim 19, further comprising at least one faceplate arranged on the at least one air outlet.

23. The air vent according to claim 19, wherein the partition has a wing-shape.

24. The air vent according to claim 22, wherein the at least one air outlet is formed by the faceplate and a wall that defines the chamber.

25. The air vent according to claim 19, wherein the adjustment device includes a drive.

26. The air vent according to claim 19, wherein the adjustment device includes a transmission.

27. The air vent according to claim 26, wherein the transmission is a ring gear transmission.

28. The air vent according to claim 19, wherein the at least one air outlet includes a first air outlet and a second air outlet, the chamber being divideable by the partition so that the first air outlet is blocked and the airflow is supplied to the second air outlet.

29. The air vent according to claim 19, wherein the at least one air outlet is shaped so that the airflow is conducted in a particular direction.

30. The air vent according to claim 24, wherein the faceplate and the wall defining the chamber at least in part form a shape of the at least one air outlet.

31. The air vent according to claim 19, wherein the at least one air outlet includes a first air outlet with an outflow direction and a second air outlet with an outflow direction, the outflow directions being oriented so that meeting airflows of the first air outlet and of the second air outlet overlap one another to form a third direction.

32. The air vent according to claim 19, wherein the partition is symmetrical with respect to each of two center point axes that are at right-angles to one another.

33. The air vent according to claim 19, further comprising at least one guide wall that laterally deflects the airflow.

34. The air vent according to claim 33, wherein the guide wall is mounted on the partition.

35. A vehicle passenger compartment, comprising: a console; trim; and at least one air vent according to claim 19 provided in at least one region of the trim and/or the console.

36. The vehicle passenger compartment according to claim 35, wherein at least two air vents are arranged so that the air outlets are flush with one another.
